(19) United States
(12) Patent Application Publication
(10) Pub. No.: US 2002/0023123 A1
(43) Pub. Date: Feb. 21, 2002

(54) GEOGRAPHIC DATA LOCATOR

(76) Inventor: JUSTIN P. MADISON, RICHARDSON, TX (US)

Correspondence Address: STEPHAN J FILIPEK, FISH & RICHARDSON PC, 45 ROCKEFELLER PLAZA, NEW YORK, NY, 10111

(21) Appl. No.: 09/360,901

(22) Filed: Jul. 26, 1999

(51) Int. Cl. G06F 15/16

(52) U.S. Cl. 709/203; 709/228

(57) ABSTRACT

A geographic information transfer method and system is described. The method includes receiving at a host system server data describing a client computer's connection to a computer network, querying a database to obtain geographic data associated with the received data, and transmitting localized information from the host system to the client computer based on the geographic data. A geographic cookie file may be generated and written to a client computer for future use. The geographic cookie file may be used to transmit localized data or to block transmission of data to a specified geographic location.

### BACKGROUND

The invention pertains to a software utility that provides data to a host regarding the location of clients on a computer network, for example, the Internet. In particular, a geographic locator application program provides a host computer on the World Wide Web (the “Web”) with the geographic location of a client browser.

The Internet is a growing, decentralized network of networks that connects computers and computer networks together. The computers comprising the Internet are owned by a variety of parties, and adhere to a basic set of communications standards known as the Internet Protocol (IP). The Internet is able to support communications using standard network protocols known as the Transmission Control Protocol (TCP/IP).

The Web is the popular “multimedia” segment of the Internet, and is the primary platform for electronic commerce. Computers on the Web support a standard set of rules for the exchange of information, and web-based documents are formatted using common coding languages such as Hypertext Markup Language (HTML) and Java. A growing number of destination sites on the Web (“websites”), are composed of individual electronic documents known as Web pages. Websites are stored on servers throughout the world and may be viewed with Web “browsing” software such as Netscape Navigator™ and Microsoft Internet Explorer™. Each website and Web page has a unique online address, defined by its Uniform Resource Locator (URL), and may contain a full range of multimedia content such as text, sound, dynamically changing images, streaming media, animation and video.

Client computers may access the Web and/or proprietary networks in a variety of ways. For example, two types of companies that provide Internet access are known as Internet Service Providers (ISP's) and Online service providers (OAP's). OAP's, such as America Online, Inc., offer proprietary online content and services to subscribers in a closed system in exchange for fees, and also allow users to access services from the Internet. An ISP furnishes access to the Internet, typically via telecommunications lines, to client computers in multiple geographic locations. In addition, ISP's offer services such as Website hosting, electronic mail (e-mail) and other Internet-based resources. ISP's and OAP's typically provide their customers with the software required to enable them to use and access the Internet and the Web. Such software may include browser software, client/server software, encryption software and payment systems for online purchasing.

Websites may contain data or information that is localized in nature, meaning that the data pertains to an event or advertisement of interest only in a particular geographic location. For example, it may be desirable to provide local retail store advertisements only to client computers of a particular area. Moreover, it may be desirable to prevent users in a specific geographic region from accessing certain data. For example, it may be desirable to “black out” a streaming media Internet broadcast of a sporting event for users residing in the home team's geographic area. To implement such data localization, software utilized by a Website or by an ISP may require users to provide localization identity data to identify a location of interest. For example, the software may require that a user enter an address, phone number, zip code and/or other location identification data.

### SUMMARY OF THE INVENTION

A geographic information transfer method is presented. The method comprises receiving at a host system server data describing a client computer's connection to a computer network, querying a database to obtain geographic data associated with the received data, and transmitting localized information from the host system to the client computer based on the geographic data.

Implementations of the method may include one or more of the following features. The received data may be internet access provider data. The method may include generating a geographic cookie file containing the geographic data when a new client computer accesses the website, and writing the cookie file to the client computer for future use. The method may also include generating a new geographic cookie file if an access number used by the client computer to connect to the computer network has changed. The geographic cookie may include information specifying at least one of zip code, city, state, latitude and longitude of a client computer. The transfer method may be implemented using ActiveX technology, or may be implemented as a Web browser plug-in program.

In another implementation, a geographic information transfer method for a website includes determining if a geographic cookie file exists on a client machine, determining whether the client machine connected to a computer network is using a previously used access number, and providing geographic data to the website server if the geographic cookie exists and the client machine used the same access number.

This implementation may include one or more of the following features. The method may further include obtaining the client browser local access number and exchange number if the geographic cookie does not exist or if the client computer access number has changed, comparing the access and exchange numbers with information in a database to determine an Internet Access Provider (IAP) name and area code, and determining location information based on the IAP exchange and area code, writing information to the client computer as a geographic cookie, and providing geographic data to the website server. The method may also include transmitting target information to client computers having acceptable geographic data. The method may also include blocking target information from being transmitted to client computers having unacceptable geographic data.

In yet another implementation, a geographic information transfer method for a website includes querying a client computer to obtain data from a geographic cookie file, if a geographic cookie file is not found generating a geographic cookie file containing location data and loading the geographic cookie file onto the client computer, wherein the cookie file is created by obtaining the dial-in access number and exchange number of an Internet Service Provider and comparing the access number and exchange number with information in a database to determine location information, and sending localized information to a plurality of client computers based on the cookie file data of each client.

In an alternate implementation, a method for blocking the transfer of data includes receiving at a host system server Internet Access Provider (IAP) data indicative of a geographic area of a client computer, querying a database to obtain geographic data associated with the received IAP data, comparing the geographic data to a predetermined data list indicative of at least one geographic area that is to be blocked from receiving specified data, and blocking the transmittal of the specified data from the host system to the client computer if the client computer's geographic data matches data in the data list.

In a computer software implementation, the software is embodied in a computer-readable medium or a propagated carrier signal, and includes instructions for causing a computer to receive at a host system server Internet Access Provider data of a client computer, query a database to obtain geographic data associated with the IAP data, and transmit localized information from the host system to the client computer based on the geographic data.

Implementations of the software implementation may include one or more of the following features. The software may include instructions to generate a geographic cookie file containing the geographic data when a new client computer accesses the website, and to write the cookie file to the client computer for future use. The software may further include instructions to generate a new geographic cookie file if a dial-up access number of the client computer has changed. The geographic cookie file may include information concerning at least one of zip code, city, state, latitude and longitude.

A host system implementation includes a database comprising records to associate Internet Access Provider (IAP) data of a client computer with location data, an interface operatively coupled to a communications link to exchange data with a terminal server, and a processor operatively coupled to the interface and to the database, the processor being configured to receive geographic data associated with the IAP data, and to transmit localized information from the host system to the client computer based on the geographic data.

The host system may include one or more of the following features. The processor may generate a geographic cookie file containing the geographic data when a new client computer accesses the host system, and write the cookie file to the client computer for future use. Further, the processor may generate a new geographic cookie file if a dial-up access number of the client computer has changed. In addition, the geographic cookie file may include information concerning at least one of zip code, city, state, latitude and longitude.

The techniques and mechanisms described here may provide one or more of the following advantages. A website may provide localized data, such as advertisements for products or services available in only certain geographic regions, to only those clients located in the regions who may be interested in recieving such information. Alternately, a website may block transmission of data, such as a broadcast of a sporting event, to certain geographic regions at the request of the content provider. Thus, an Internet website can safely offer content that a copyright owner otherwise feels cannot be protected against market exclusivity.

These and other advantages will be apparent from the specification, claims and drawings.

### DRAWING DESCRIPTIONS

FIG. 1 is a computer hardware diagram.

FIG. 2 is a computer network diagram.

FIG. 3 is a flowchart of an implementation of a method according to the invention.

### DETAILED DESCRIPTION

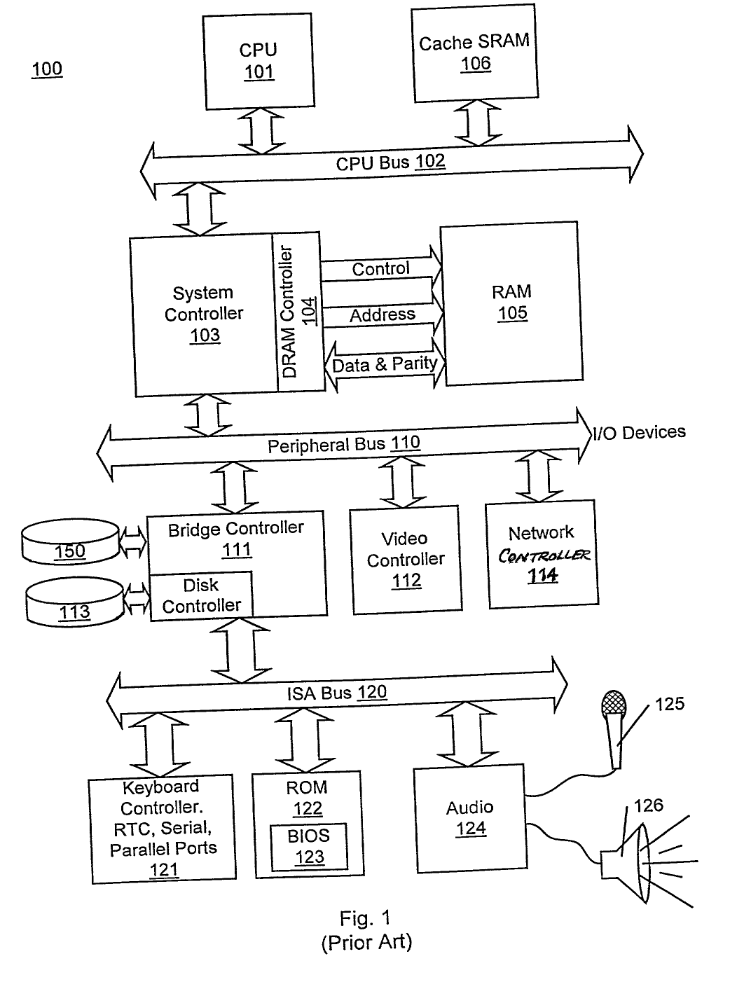

FIG. 1 depicts physical resources of a typical computer system 100. The computer 100 has a central processor 101 connected to a processor host bus 102 over which it provides data, address and control signals. The processor 101 may be any conventional general purpose single- or multi-chip microprocessor such as a Pentium® processor, a Pentium® Pro processor, a Pentium II® processor, a Pentium III® processor, a MIPS® processor, a Power PC® processor or an ALPHA® processor. In addition, the processor 101 may be any conventional special purpose microprocessor such as a digital signal processor or a graphics processor. The microprocessor 101 has conventional address, data, and control lines coupling it to a processor host bus 102.

The computer 100 includes a system controller 103 having an integrated RAM memory controller 104. The system controller 103 is connected to the host bus 102 and provides an interface to random access memory 105. The system controller 103 also provides host bus to peripheral bus bridging functions. The controller 103 thereby permits signals on the processor host bus 102 to be compatibly exchanged with signals on a primary peripheral bus 110. The peripheral bus 110 may be, for example, a Peripheral Component Interconnect (PCI) bus, an Industry Standard Architecture (ISA) bus, or a Micro-Channel bus. The controller 103 can also provide data buffering and data transfer rate matching between the host bus 102 and peripheral bus 110. The controller 103 thereby allows, for example, a processor 101 having a 64-bit 66 MHz interface and a 533 Mbytes/second data transfer rate to interface to a PCI bus 110 having a data path differing in data path bit width, clock speed, or data transfer rate.

Accessory devices including, for example, a video display controller 112 and network controller 114 may be coupled to the peripheral bus 110. The network controller 114 may be a modem, an Ethernet networking card, a cable modem, or other network access device. The system 100 may also include a secondary peripheral bus 120 coupled to the primary peripheral bus 110 through a bridge controller 111. The secondary peripheral bus 120 may provide additional peripheral device connection points or may be used to connect peripheral devices that are not compatible with the primary peripheral bus 110. For example, the secondary bus 120 may be an ISA bus and the primary bus 110 may be a PCI bus, which allows ISA devices to be coupled to the ISA bus 120 and PCI devices to be coupled to the PCI bus 110. The bridge controller 111 may also include a hard disk drive control interface to couple a hard disk 113 to the peripheral bus 110, and a controller to couple to other computer readable media 150.

The computer 100 also includes non-volatile readonly memory (“ROM”) 122 to store basic computer software routines. However, the ROM 122 may include alterable memory, such as EEPROM (Electronically Erasable Programmable Read Only Memory), to store configuration data such as hard disk 113 geometry and configuration data. BIOS routines 123 are included in ROM 122 and provide basic computer initialization, systems testing, and input/output (I/O) services. For example, BIOS routines 123 may be executed by the processor 101 to process interrupts that occur when the bridge controller 111 attempts to transfer data from the ISA bus 120 to the host bus 102 via the bridge 111, peripheral bus 110, and system controller 103. The BIOS 123 also includes routines that allow an operating system to be “booted” from the disk 113 or from a server computer using a local area network connection provided by the network adapter 114. The operating system boot operation can occur after the computer 100 is turned on and power-on self-test (POST) routines stored in the BIOS 123 complete execution, or when a reset switch is depressed, or following a software-initialed system reset or a software fault. During the boot process, the processor 101 executes BIOS 123 software to access the disk controller 111 or network controller 114 and thereby obtain a high-level operating system. The high-level operating system is, for example, the Microsoft Disk Operating System (DOS)™, Windows 95™, Windows 98™, Windows NT™, a UNIX operating system, the Linux operating system, the Apple Mac OS™ operating system, or another operating system.

An operating system may be fully loaded in the RAM memory 105 or may include portions in RAM memory 105, disk drive storage 113, or storage at a network location. For example, the Microsoft Windows 95™ operating system includes some functionality that remains in memory 105 during the use of Windows 95™ and other functionality that is periodically loaded into RAM memory 105 on an as-needed basis from, for example, the hard disk 113. Operating systems also provide functionality to control computer peripherals such as the video controller 112, network controller 114, keyboard controller, serial and parallel ports 121 and the audio circuitry 124, and to execute user applications. User applications may be commercially available software programs to provide capability for word processing, spreadsheets, computer-aided design, manufacturing inventory, scientific applications, Internet access and many other types of applications. User applications may access computer system peripherals 112-114, 121, and 124 through an application programming interface provided by the operating system and/or may directly interact with underlying computer system 100 hardware.

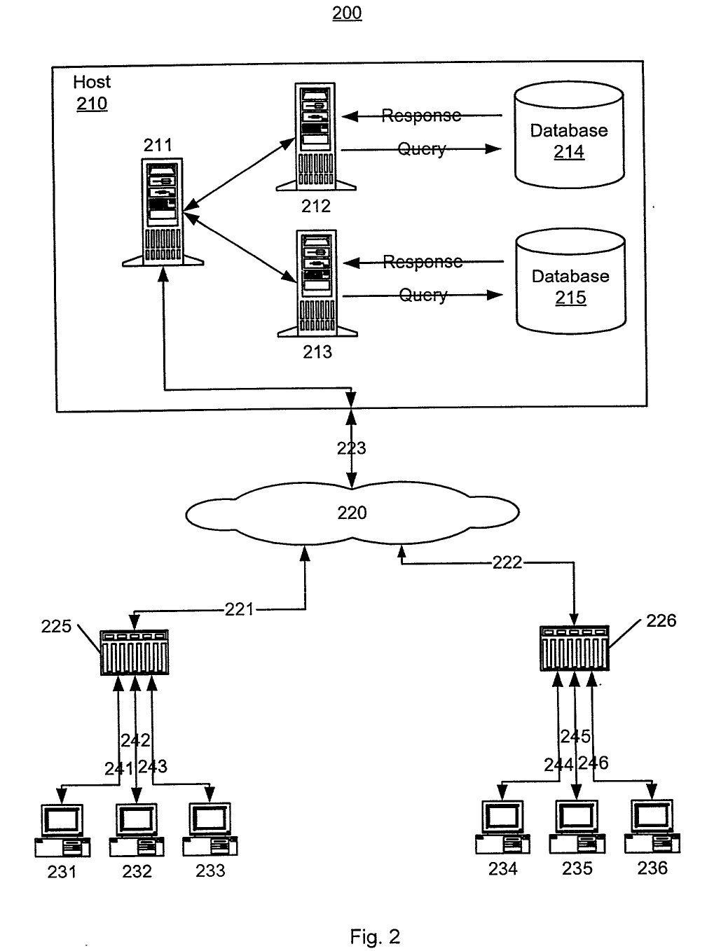

A collection of computers 100 may be connected together as components of a computer network. FIG. 2 illustrates a computer network 200 which may include a host computer system 210 and client computers 231-233 and/or other network access devices 234-236. Users utilize the client computers 231-233 or other network access devices 234-236 to communicate with the host 210 to obtain data stored at the host 210 in a local database 214 or stored in a distant database 215. The client computers 231-233 or other network access devices 234-236 can interact with the host computer 210 as if the host was a single entity in the network 200. The host 210, however, may include multiple processing and database sub-systems that can be geographically dispersed through the network 200. For example, the host 210 may include a single computer server 211 or a tightly coupled cluster of computers 211-213 at a first location that may access a local database system 214 or remote database 215. Each database system 214 or 215 may include additional processing components.

Client computers 231-233 or other network access devices 234-236 can communicate with a host system 210 over, for example, a combination of public switched telephone network dial-up connections and packet network interconnections. For example, client computers 231-233 may each include a modem coupled to voiceband telephone lines 241-243. To communicate with the host 210, the client computer 231 can establish a data connection with a local terminal server 225 by dialing a telephone number assigned to the local terminal server 225. Other network access devices 232-233 can connect through dial up, direct cable access, wireless transmission and/or other communications media. A local terminal server 225 or 226 may have both dial-up and packet network interfaces allowing the server 225 or 226 to receive data from client computers 231-233 or other network access devices 234-236, segment the received data into data packet payload segments, add overhead information to the payload segments, and send the resultant data packets over a link 221 or 222 to a packet data network 220 such as the Internet for delivery to the host system 210. Terminal servers 225 and 226 may also be referred to as a network service provider's or an ISP's point-of-presence (POP).

The overhead information added to the payload segments include a packet header. A packet header includes a destination address assigned to the host system 210 and a source address assigned to the local terminal server 225. Other overhead information may include information associating the data packet with a specific client 231-233. Similarly, the host system 210 may send data to a client 231-233 by segmenting the data into data packet payload segments, and adding overhead information to send the data packet to a client 231-234 at the terminal server 225. Client computers 234-236 may similarly exchange data with the host 210 over communications links 244-246 to the terminal server 226.

Data packet formats, switching equipment within the packet network 220, and networking protocols used within the network 200 may conform to the transaction control protocol/internet protocol (TCP/IP). In a TCP/IP implementation, the host 210, packet network 220, terminal servers 225 and 226 are each assigned a unique internet protocol (IP) network address. TCP/IP switching equipment within the network 220 directs a TCP/IP packet to the intended recipient 210, 225, or 226 based on the packet's destination IP address. Implementations may use other networking protocols and packet formats.

Although some client computers may have fixed IP addresses, the vast majority of client computers 231-233 gain access to the Web indirectly by using an ISP or OAP and dialing a local telephone number to connect to a host server. Such users do not have an IP address for their respective client computers but rather potentially may have a different IP address each time they connect to the host server. Specifically, a user's client computer effectively will have the IP address of the particular terminal server to which it is connected for that session. Most Internet access providers (IAP's) permit the use of client browser software, such as Microsoft Internet Explorer™ or Netscape Navigator™ to access the Web and/or to access Internet resources. It should be understood that the term IAP encompasses all companies that provide access to the Internet, such as ISP's and OAP's.

The locator application program provides a Web server with the geographic location of a client browser. When a commercial website is accessed by a client, an implementation of the locator program first checks to see if a geographic “cookie” file exists on the client computer. A cookie, sometimes referred to as a “magic cookie” is a short piece of data downloaded to a client's computer which may be read back by a website during subsequent interactions. In effect, a cookie is a token that allows the computers involved to remember, and refer to, past transactions. The cookie typically includes a small text file with information pertaining to a client's access to the website, and is sent to the client's computer while the website is being accessed or after the website has been accessed. The text file is presented to the server hosting the website by the client's browser, and is typically used to avoid the necessity of repeating information submitted during a previous interaction. Cookies also may be used to tell a server if a client has visited the website before. Some cookies reside in a computer's random access memory (RAM) and are erased when a client exits its browser. Non-volatile cookies are stored on a client's hard drive and referred to as persistent cookies.

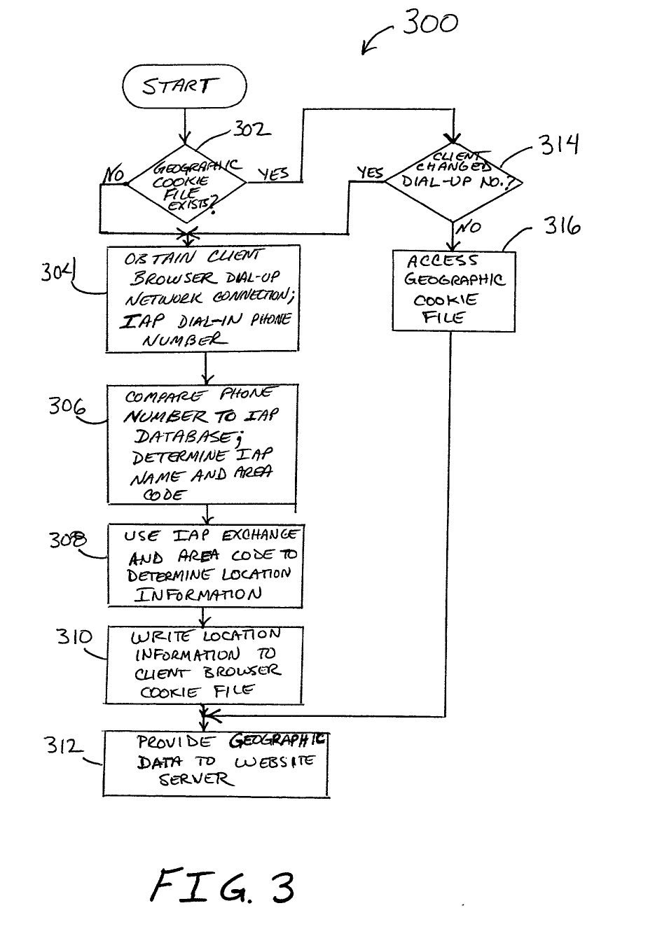

FIG. 3 is a flowchart of the locator program 300 illustrating the steps followed when a client accesses a website that utilizes the locator. In step 302 the locator determines if a geographic cookie, which is a text file containing geographic location data as explained below, exists on the client machine that has accessed the website. If a geographic cookie does not exist, then the locator program will generate one. Thus, in step 304 the dial-up networking connection is used to obtain the client browser's local ISP dial-in phone number. In step 306, the Locator transmits this number to a website that accesses a database of ISP information to determine the ISP's name and the area code for the dial-in number. In step 308, the ISP exchange and area code are used to determine location information such as the zip code, city, state, latitude, and longitude of the client computer. The exchange is the three digit number following the area code in the ISP dial-in telephone number. In step 310 the location information is written into the browser geographic cookie file or directory on the client computer. The geographic cookie contains at least one of the state, city, zip code, latitude and longitude of the client browser. In step 312, the geographic information is supplied to the website server, which can then use the geographic information to target advertising to, and to glean demographic information from, the client. The locator program needs to perform this operation only once for each client computer. From then on, the geographic cookie can be used by the server hosting the website without having to access another database.

Referring again to FIG. 3, if a client accesses a website, and the locator in step 302 determines that a geographic cookie is resident, but in step 314 determines that the client changed his dial-up number, then steps 304 to 312 will be executed again to generate a new geographic cookie. In this manner, if the client machine moves to a new location then a new, updated cookie will be placed on the machine. However, if the client has not changed its dial-up number in step 314, then the existing geographic cookie file will be accessed in step 316, and the data therein will be provided to the website server in step 312.

The locator program may be implemented as an ActiveX control or as a Netscape Plug-in program and will provide a webserver with the geographic location of a client browser. The webserver can then use this information to display to a client information targeted to the location of that client. This information also can be used to enhance the database that the webserver uses to track clients.

ActiveX is a technology from Microsoft® that can add multimedia and interactivity to a client browser program. As a result, the client computer and the Internet effectively interact as if they were one large computer system. ActiveX controls can be created using various programming tools such as Visual Basic or the C programming language. Examples of ActiveX applications include news tickers, interactive games with multiple players, and multimedia presentations combining animation, sounds, music and graphics. ActiveX programs are referred to as ActiveX “controls” or “components” and are downloaded to, and executed on, a client computer. ActiveX controls are supported by various browser software, such as Microsoft Internet Explorer™, Version 3.02 and later versions, and can perform normal application functions in addition to interacting with the Web, the Internet and other computers connected to the Internet. Because ActiveX controls are written as components, they are modular and can be put together like building blocks to build larger and more complex applications. In addition, once an ActiveX component has been downloaded, a client need not download the same component again so that when another ActiveX application is required, only a small portion may need to be downloaded if the other components are already resident on the client computer. When a client visits a Website containing an ActiveX control, the Internet Explorer™ browser recognizes the HTML <object> tag, automatically downloads the control, and presents the client with a digital certificate that authenticates the control. The user then decides whether or not to install the control.

Netscape Communicator is a software program that offers a complete set of Internet applications, and includes the popular Netscape Navigator™ Web browser. Netscape implemented a set of technologies called the JAR Installation Manager (JIM) (a JAR file is a file formaat that defines an installation of a JAVA class). JIM enables a SmartUpdate feature of Netscape Communicator and Netscape Communicator Professional Edition, as well as the AutoInstall feature of Netscape Mission Control. JIM thus provides tools to automatically and securely install software on a user's machine. The locator software can be installed using these technologies as a Netscape Navigator plug-in program. To ensure authenticity, the plug-in must be signed with a digital certificate. When Netscape Communicator loads a page with an embedded plug-in that is not installed on the client machine, JIM will download the plug-in and present a digital certificate to the user. The user then decides whether or not to install the program.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments of the present invention have been described. Nevertheless, it will be understood that various modifications may be made without departing from the spirit and scope of the invention. Accordingly, other implementations are within the scope of the following claims.

What is claimed is:

1. A geographic information transfer method comprising:
receiving at a host system server data describing a client computer's connection to a computer network;
querying a database to obtain geographic data associated with the received data; and
transmitting localized information from the host system to the client computer based on the geographic data.

2. The method of claim 1 wherein the data is internet access provider data.

3. The method of claim 1, further comprising:
generating a geographic cookie file containing the geographic data when a new client computer accesses the website; and
writing the cookie file to the client computer for future use.

4. The method of claim 3, further comprising generating a new geographic cookie file if an access number used by the client computer to connect to the computer network has changed.

5. The method of claim 3, wherein the geographic cookie includes information specifying at least one of zip code, city, state, latitude and longitude of a client computer.

6. The method of claim 1, wherein the transfer method is implemented using ActiveX technology.

7. The method of claim 1, wherein the transfer method is implemented as a Web browser plug-in program.

8. A geographic information transfer method for a website, the method comprising:
determining if a geographic cookie file exists on a client machine;
determining whether the client machine connected to a computer network is using a previously used access number; and
providing geographic data to the website server if the geographic cookie exists and the client machine used the same access number.

9. The method of claim 8, further comprising:
obtaining the client browser local access number and exchange number if the geographic cookie does not exist or if the client computer access number has changed;
comparing the access and exchange numbers with information in a database to determine an Internet Access Provider (IAP) name and area code;
determining location information based on the IAP exchange and area code;
writing information to the client computer as a geographic cookie; and
providing geographic data to the website server.

10. The method of claim 8, further comprising transmitting target information to client computers having acceptable geographic data.

11. The method of claim 8, further comprising blocking target information from being transmitted to client computers having unacceptable geographic data.

12. A geographic information transfer method for a website, the method comprising:
querying a client computer to obtain data from a geographic cookie file;
if a geographic cookie file is not found generating a geographic cookie file containing location data and loading the geographic cookie file onto the client computer, wherein the cookie file is created by obtaining the dial-in access number and exchange number of an Internet Service Provider and comparing the access number and exchange number with information in a database to determine location information; and
sending localized information to a plurality of client computers based on the cookie file data of each client.

13. A method for blocking the transfer of data, the method comprising:
receiving at a host system server Internet Access Provider (IAP) data indicative of a geographic area of a client computer;
querying a database to obtain geographic data associated with the received IAP data;
comparing the geographic data to a predetermined data list indicative of at least one geographic area that is to be blocked from receiving specified data; and
blocking the transmittal of the specified data from the host system to the client computer if the client computer's geographic data matches data in the data list.

14. Computer software embodied in a computer-readable medium or a propagated carrier signal, the computer software comprising instructions for causing a computer to:
receive at a host system server Internet Access Provider data of a client computer;
query a database to obtain geographic data associated with the IAP data; and
transmit localized information from the host system to the client computer based on the geographic data.

15. The software of claim 14, further comprising instructions to:
generate a geographic cookie file containing the geographic data when a new client computer accesses the website; and
write the cookie file to the client computer for future use.

16. The software of claim 15, further comprising instructions to generate a new geographic cookie file if a dial-up access number of the client computer has changed.

17. The software of claim 15, wherein the geographic cookie file includes information concerning at least one of zip code, city, state, latitude and longitude.

18. A host system comprising:
a database comprising records to associate Internet Access Provider (IAP) data of a client computer with location data;
an interface operatively coupled to a communications link to exchange data with a terminal server; and
a processor operatively coupled to the interface and to the database, the processor being configured to receive geographic data associated with the IAP data, and to transmit localized information from the host system to the client computer based on the geographic data.

19. The host system of claim 18 wherein the processor generates a geographic cookie file containing the geographic data when a new client computer accesses the host system, and writes the cookie file to the client computer for future use.

20. The host system of claim 19, wherein the processor generates a new geographic cookie file if a dial-up access number of the client computer has changed.

21. The host system of claim 19, wherein the geographic cookie file includes information concerning at least one of zip code, city, state, latitude and longitude.
